(19) United States
(12) Patent Application Publication
(10) Pub. No.: US 2025/0111692 A1
(43) Pub. Date: Apr. 3, 2025

(54) INFORMATION PROCESSING APPARATUS, INFORMATION PROCESSING METHOD AND INFORMATION PROCESSING PROGRAM

(71) Applicant: NEC Communication Systerns, Ltd., Minato-ku, Tokyo (JP)

(72) Inventors: Norihiko KAMATA, Tokyo (JP); Masakazu Kaneda, Tokyo (JP); Kenichi ABE, Tokyo (JP); Akira MATSUMOTO, Tokyo (JP); Satoki UENO, Tokyo (JP); Tetsuya ITO, Tokyo (JP); Chikashi ITO, Tokyo (JP); Momo SUTO, Tokyo (JP)

(73) Assignee: NEC Communication Systerns, Ltd., Minato-ku, Tokyo (JP)

(21) Appl. No.: 18/728,947

(22) PCT Filed: Jan. 30, 2023
(86) PCT No.: PCT/JP2023/002818

§ 371 Date: Jul. 15, 2024

(30) Foreign Application Priority Data
Jan. 31, 2022 (JP) 2022-013330

(51) Int. Cl. G06V 40/10; A01K 29/00; G01J 5/00; G06T 7/70; G06V 10/74

(52) U.S. Cl. CPC G06V 40/10; A01K 29/005; G01J 5/0025; G06T 7/70; G06V 10/74; G01J 2005/0077; G06T 2207/30188

(57) ABSTRACT

Images of a livestock are taken, identifiers of the livestock are acquired, and the identifiers acquired and the images taken are stored in association with one another in a storage part. The images of the livestock identified by the same identifier, which had taken at different time points, are compared. Replacement of the livestock identified by the same identifier is reported when a change in the livestock that cannot occur during a predetermined time span is detected as a result of comparison.

### FIELD

### Cross-Reference to Related Application

The present invention is based on the priority of Japanese patent application No. 2022-013330 (filed on Jan. 31, 2022), the entire contents of the same application are incorporated by reference in the present application.

The present invention relates an information processing apparatus, an information processing method and an information processing program.

Particularly, the present invention relates to an information processing apparatus, an information processing method and an information processing program relating to animal welfare.

### BACKGROUND

With respect to cattle, a system is in operation, in which a tag issued by a governmental organization is attached to an ear of cattle to be raised and an individual identification number is assigned to the cattle so as to ensure that the cattle is the same individual from the start of raising until slaughter. This system is also called as Traceability Law and is used for a food safety purpose and for a purpose of recalling products that have been distributed during a BSE outbreak.

In addition, in recent years, special rearing methods have been implemented, such as animal welfare certification, organic JAS certification, chemical-free rearing, and grass-fed rearing, which require more labor and cost than a conventional standard rearing method thereby achieving higher selling price than those raised by the standard rearing method. Here, in order to certify that livestock have been reared according to a prescribed rearing method, it is necessary to maintain rearing history, to identify individuals and to link them to the rearing history, so as to certify that they are surely individuals who have been reared according to the rearing history. In other words, individual identification for a purpose of adding value is necessary. Therefore, it can be said that a benefit of certifying that the same livestock, not only cattle, is raised from start of raising until slaughter is increasing. In addition, the benefit by certifying a traceability of article of goods, not only livestock, is also increasing.

For example, Patent Literature 1 (PTL 1) discloses an individual identification tool for identifying livestock Patent Literature 2 discloses a livestock management system based on nasal print authentication. Furthermore, Patent Literature 3 discloses a judgment system for determining the place of origin of cattle.

### CITATION LIST

### Patent Literature

PTL 1: Tokkai JPHei 6-276877A
PTL 2: Tokkai JP2001-148957A
PTL 1: Tokkai JP2021-140773A

### SUMMARY

### Technical Problem

The following analysis is made from an aspect of the present invention. Herein, disclosures of the documents cited in the Citation List is incorporated in the present application by reference thereto.

The technologies of Patent Literatures 1-3 have a problem that it is vulnerable against a fraud by a malicious person who secretly replaces a livestock linked to a tag. That is, the technologies of Patent Literatures 1-3 merely certify that a tag issued by a governmental organization is the same during a time period from start of raising until slaughter. Therefore, a malicious person may unfairly get a profit by, for example, in a case where an individual raised by a special rearing method had got ill or died, replacing the individual with another individual raised by a standard rearing method.

Under the Traceability Law, reporting of cattle death is mandatory, and a measure has been taken against the fraud as described above. However, there is no system for prohibiting such fraud above for other livestock (e.g., pigs, chickens, etc.). Furthermore, mandatory reporting under the law may provide a psychological deterrent to such fraud but may not provide immediate detection of such fraud.

In addition, with respect to cattle, since individual identification is ultimately performed by nose print authentication, there is a lot of labor involved. There is also a problem that such fraud cannot be detected unless a supervisor or other person suspects such fraud and actively investigates (e.g., by collating nose prints).

Accordingly, it is a purpose of the present invention to provide a technology which easily realize animal welfare-conscious livestock raising management.

### Solution to Problem

According to a first aspect of the present invention, there is provided an information processing apparatus, comprising:
a camera that takes images of a livestock,
an identifier acquiring part that acquires an identifier of the livestock,
a storage part that stores the identifier acquired by the identifier acquiring part and the images taken by the camera in association with one another,
an image comparing part that compares the images of the livestock identified by the same identifier, which have been taken at different time points, and
a reporting part that reports replacement of the livestock identified by the same identifier when a change in the livestock that cannot occur during a predetermined time span is detected as a result of comparison by the image comparing part.

According to a second aspect of the present invention, there is provided an information processing method, comprising:
an image taking step of taking images of a livestock,
an identifier acquiring step of acquiring an identifier of the livestock,
a storing step of storing the identifier acquired and the images in association with one another in a storage part,
an image comparing step of comparing the images of the livestock identified by the same identifier, which have been taken at different time points, and
a reporting step of reporting replacement of the livestock identified by the same identifier when a change in the livestock that cannot occur during a predetermined period is detected as a result of comparison.

According to a third aspect of the present invention, there is provided an information processing program, causing a computer to execute:
an image taking process of taking images of a livestock, an identifier acquiring process of acquiring an identifier of the livestock,
a storing process of storing the identifier acquired and the images in association with one another in a storage part,
an image comparing process of comparing the images of the livestock identified by the same identifier, which have been taken at different time points, and
a reporting process of reporting replacement of the livestock identified by the same identifier when a change in the livestock that cannot occur during a predetermined period is detected as a result of comparison.

### Advantageous Effects of Invention

According to each aspect of the present invention, there are provided an information processing apparatus, an information processing method and an information processing program that contribute to easily realize an animal welfare-conscious livestock raising management.

### BRIEF DESCRIPTION OF THE DRAWINGS

FIG. 1 is an explanatory view of an outline of the present invention.

FIG. 2 is a diagram showing an example of a fraud concerned in the present application.

FIG. 3 is a diagram showing an example of a fraud concerned in the present application.

FIG. 4 (FIG. 4A, FIG. 4B) is a conceptual explanatory diagram of the present invention.

FIG. 5 is a block diagram showing an exemplary configuration of an information processing apparatus 100 of an exemplary embodiment 1.

FIG. 6 is a diagram showing an example of arrangement of a camera 10 considered in the present application.

FIG. 7 is a flowchart diagram showing a flow of processes by the information processing apparatus 100.

FIG. 8 is a diagram showing an example of a computer as the information processing apparatus 100.

### EXAMPLE EMBODIMENTS

Preferable exemplary embodiments which may be realized by the present invention is explained in detail with reference to the drawings. Herein, reference signs in the following description are expediently attached to each element as an explanatory aid for understanding, but not for limitation of the present invention to an illustrated configuration. In addition, connection lines between blocks in each figure include both of bidirectional and one directional. One way arrow schematically indicates a flow of main signal (data), thus does not exclude bidirectional. In addition, in a circuit diagram, a block diagram, an inner configuration diagram, a connection diagram, etc., illustrated in the present disclosure, an input/output ends of each connection lines respectively have input/output ports, but explicit indications thereof are omitted. The same is applied to input/output interfaces, too.

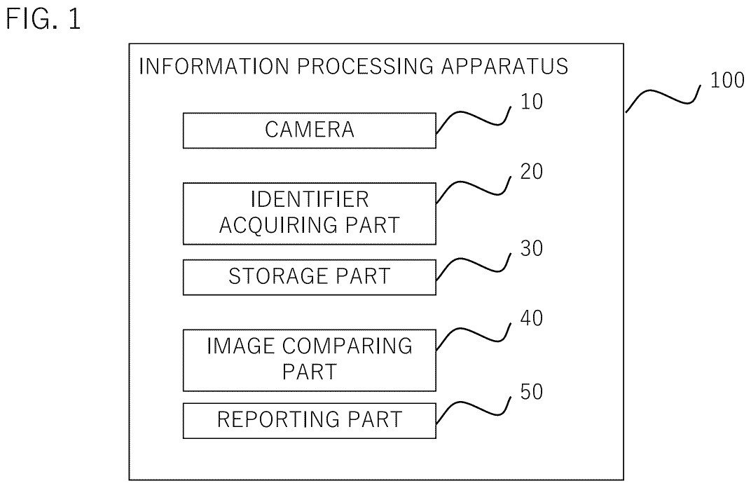

First, one outline of the present invention is explained. As illustrated in FIG. 1, an information processing apparatus 100 comprises a camera 10, an identifier acquiring part 20, a storage part 30, an image comparing part 40 and a reporting part 50.

The camera 10 takes (shoots) images of a livestock. The identifier acquiring part 20 acquires identifier of the livestock. The storage part 30 stores the identifier and the images of the livestock in association with one another. The image comparing part 40 compares the images of the livestock identified by the same identifier, which have been taken at different time points. The reporting part 50 reports replacement of the livestock identified by the same identifier when a change in the livestock that cannot occur during a predetermined period is detected as a result of comparison by the image comparing part.

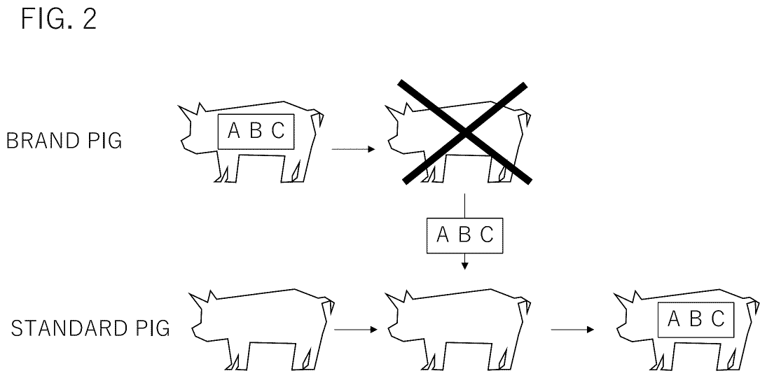

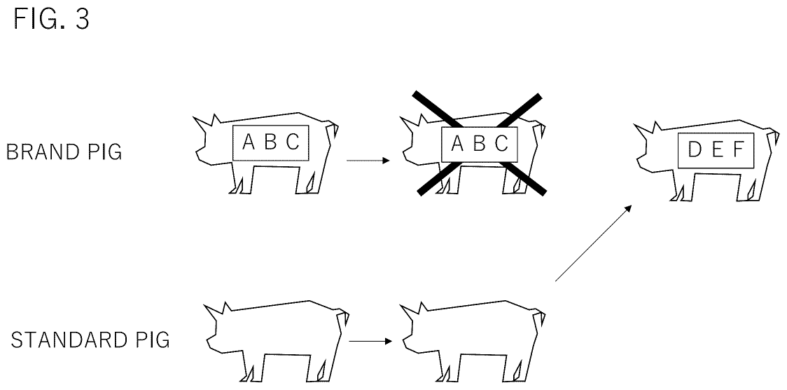

A concrete example is discussed. The information processing apparatus 100 of the present invention is presumed to report the replacement of the livestock under such cases indicated in FIGS. 2, 3. FIG. 2 shows a fraudulent case in which a tag with an identifier: ABC that had been attached to a high priced brand pig is transferred to a low priced standard pig when the brand pig died. FIG. 3 shows a fraudulent case in which, when a high priced brand pig died, a tag with an identifier: ABC that had attached to the brand pig is reported as broken, and a newly issued tag with an identifier: DEF is attached to a low priced standard pig.

Under both cases, the low priced standard pig will be traded as a brand pig. Herein, the case of FIG. 3 may occur under a situation of cattle replacement. That is, a system is carried out under Traceability Law, in which a tag used for cattle raising is usually designed so that it cannot be reattached once removed, and, as a countermeasure of breakage of the tag, another tag is allowed to be used if requested. Thus, with respect to cattle, this system may be abused upon cattle replacement. There is a possibility of occurrence of the fraud indicated in FIG. 3 by pretending breakage of the tag.

With respect to the case of FIG. 2, the information processing apparatus 100 compares an image of a brand pig and an image of a standard pig, to which the same tag with the identifier: ABC have been attached respectively. With respect to the case of FIG. 3, the information processing apparatus 100 regards that both of the identifier: ABC and the identifier: DEF relate to the same identifier, and compares an image of a brand pig attaching a tag with an identifier: ABC with a image of a standard pig attaching a tag with identifier: DEF. At that time, the information processing apparatus 100 will detect an appearance change that cannot occur during a predetermined period and report a replacement of livestock.

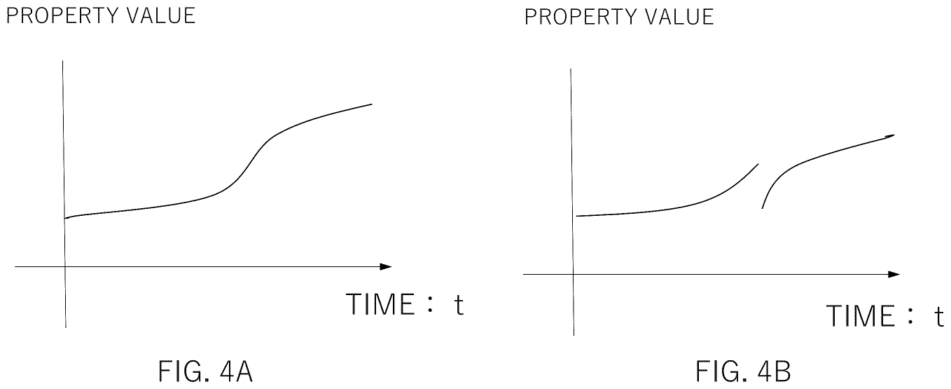

Conceptual explanation is made. As shown in FIG. 4A, a livestock is supposed to have and gradual growing up as lapse of time t in its property value, such as height, weight and the like. Therefore, it can be said that discontinuity (not successive), drastic change and non-standard change in the property value as illustrated in FIG. 4B cannot occur in the same livestock. It can be said that the information processing apparatus 100 of the present invention detects the discontinuity, the drastic change and the non-standard change during a short period (time span) in terms of the property value from the images of the livestock which have been taken regularly or periodically to report the replacement of the livestock. Herein, the property value may be also referred to as an element that does not have a drastic change during a short time span, and is exemplified by, for example, a body size, a body pattern, facial looks, body parts like ears, hair (fur) appearance, joint position and distance between joints, and relationship between them. That is, when not only numerical information, but also appearance change that cannot occur during a short time span in the same individual (for example, disappearance of spot and pattern) occurs, the information processing apparatus 100 of the present invention reports the replacement of the livestock. The information processing apparatus 100 of the present invention can be expected to have a potent effect in deterring (suppressing) the replacement of the livestock, since all images stored in the storage part 30 must be forged in order to realize the replacement of the livestock.

### Exemplary Embodiment 1

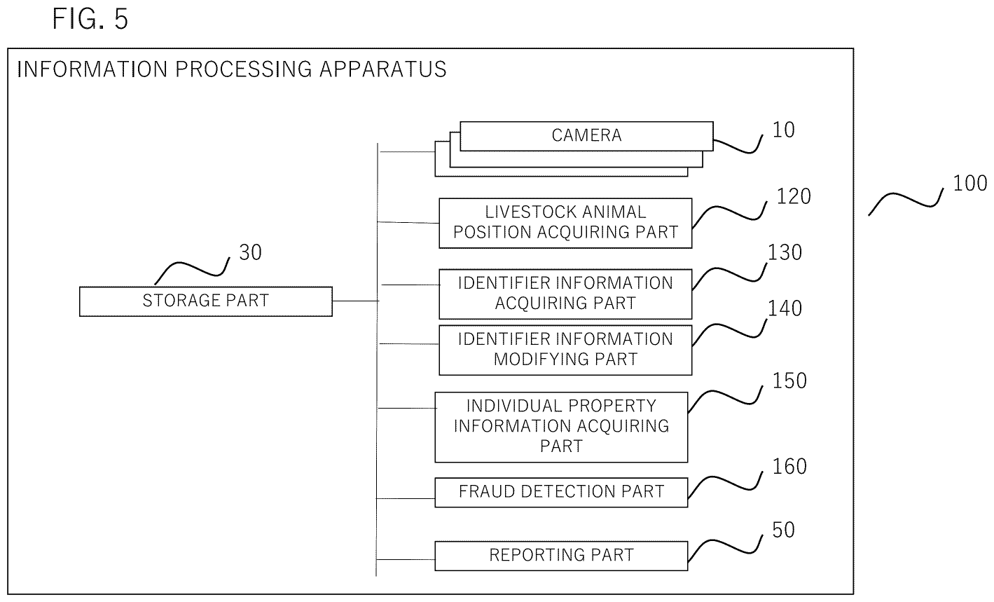

Next, as an exemplary embodiment 1, the information processing apparatus 100 is concretely explained. As illustrated in FIG. 5, the information processing apparatus 100 comprises a storage part 30, a plurality of cameras 10, a livestock position acquiring part 120, an identifier information acquiring part 130, an identifier information modifying part 140, an individual property information acquiring part 150, a fraud detection part 160 and a reporting part 50.

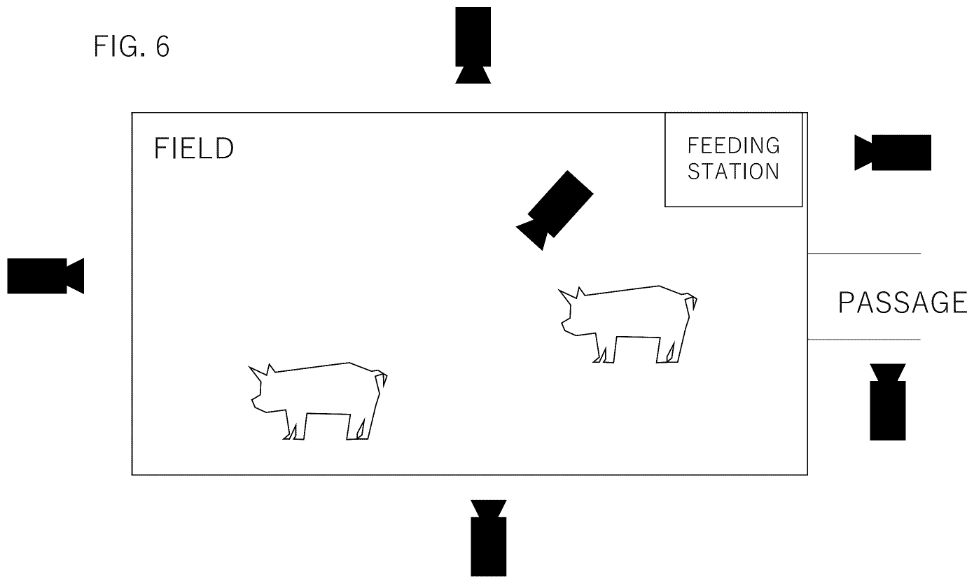

The cameras 10 are arranged, for example, at a variety of places in a field (or barn) as shown in FIG. 6 so as to regularly or intermittently take images of pigs in the field from a variety of angles of a front side, a lateral side and an upper position, and store the image in the storage part 30 in time sequence. Here, the cameras 10 may be collectively arranged at a place, such as a passage or a feeding station, where a pig is necessary to pass through there in one day. The images are preferably stored in the storage part 30 in a data format by which the position of pigs (the distance from the cameras 10) may be determined later on. The position of pigs may be determined using various technologies, for example, ToF (Time of Flight) camera, marker positioning, integration of images taken by the plurality of cameras 10. The images are also preferably stored in the storage part 30 in a data format allowing determination of capturing time point, for example, a time stamp is attached to an image. It is also preferable that the cameras 10 store a list of camera IDs (identifiers), camera position information, camera direction (orientation) information, sensor information (livestock distance information, livestock position information) in the storage part 30 together with the images.

The livestock position acquiring part 120 applies position information of the livestock to the image stored in the storage part 30. Concretely, the livestock position acquiring part 120 determines the position of a livestock in the field based on the size and position of a neighborhood livestock captured at the same time point in an image taken by the cameras 10. Here, in a case where the cameras 10 are a positioning camera or a ToF camera that are capable of acquiring livestock distance information and livestock position information, the livestock position acquiring part 120 may use such information. In other words, the ToF camera, the marker positioning camera and the like may be used as a component in which the cameras 10 and the livestock position acquiring part 120 are integrated.

The identifier information acquiring part 130 corresponds to the identifier acquiring part 20 and performs identification of individual by extracting the identifier attached to each of pigs from one image taken by the plurality of cameras 10. Concretely, the identifier information acquiring part 130 identifies individual livestock and applies individual ID information on an image taken from a direction capable of detecting information that realizes identification, such as a tag, a maker, a face and the like, among images stored in the storage part 30. It is preferable that the identifier information acquiring part 130 also applies the individual ID information to the pigs in the images based on the capturing time point, the position and distance of pigs and the like even images that cannot be applied to the identification.

The identifier information modifying part 140 is a functional part that is used when the tag has broken (the case illustrated in FIG. 3) and updates the individual ID information applied to a pig captured in the image when the individual ID information is modified. Herein, the individual ID information may be managed as a pre-modified ID and a post-modified ID in an individual ID database.

The individual property information acquiring part 150 acquires numerical information by converting property information of each individual (for example, a body size of a target individual) and position information of the livestock derived from the image stored in the storage part 30 to the numerical information [the numerical information is also referred to as “property information”]. For example, the individual property information acquiring part 150 classifies the images stored in the storage part 30 into front views, backside views, right angle views, left angle views, upper angle views and the like for each of individual IDs, and measures property values, such as the size of pig, etc., for each image to apply a property value(s) to the images. The size of pig may be measured in a variety of manners, for example, sensor fusion with 3D, marker positioning, calculation by comparison with a criterion object (striped poles, etc.) captured in an image, and the like. Herein, as a result of applying the property information by the individual property information acquiring part 150, the storage part 30 stores time sequence data of the property information for each target individual.

The fraud detection part 160 compares a past image with a new image to detect a fraud. Concretely, the fraud detection part 160 considers a fraud operation has taken place when the property information which is prospected to have a moderate fluctuation under a normal case has an abnormal drastic change during a predetermined time span, and performs a report (communication) using the reporting part 50.

Herein, the image comparing part 40 corresponds to an integrated component of the individual property information acquiring part 150 and the fraud detection part 160.

The reporting part 50 reports an occurrence of fraud action (i.e., livestock replacement) to, for example, an inspector of a certification authority or a supervisor of a parent company.

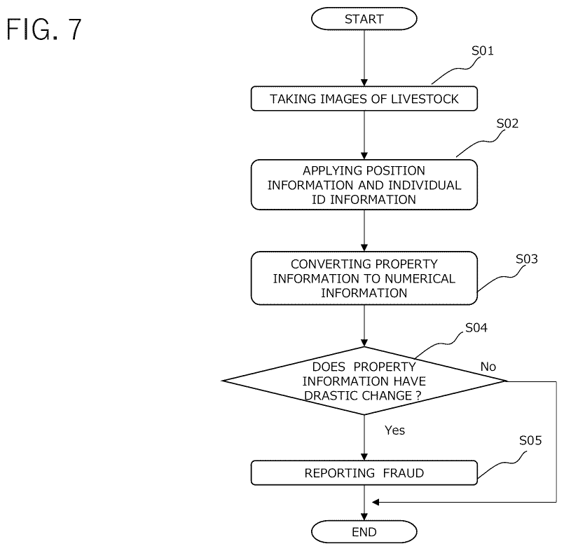

Next, a flow of processes by the information processing apparatus 100 is explained. As illustrated in FIG. 7, the information processing apparatus 100 takes (performs shooting of) an image of a livestock (Step S01) and applies position information and individual ID information thereto (Step S02). Then, the information processing apparatus 100 converts the property information of each individual to numerical information (Step S03), and if the property information which is prospected to have a moderate fluctuation under a normal case has an abnormal drastic change during a predetermined time span (Step S04, Yes), the information processing apparatus 10 reports occurrence of fraud (livestock replacement) (Step S05). Herein, Steps S01 to 03 may be regularly continued, in other words, performed in a looped manner. In addition, Step S04 may be performed at any pertinent timings. That is, the fraud may be detected by accumulating growth logs in which position information, individual ID information and property information are applied to livestock images in the storage part 30 and comparing the growth logs at a pertinent timing. Herein, if the property information has no drastic changes (Step S04, No), the information processing apparatus 100 terminates a fraud detection process, but the information processing apparatus 100 may also continue Steps S01 to 03.

Hereinafter, a variation mode of the exemplary embodiment 1 is explained.

The exemplary embodiment 1 explains a case where a fraud is detected by comparing a past image with a new image. However, the other sensor data, but not images, may be used for acquiring properties. For example, a thermo sensor (may be a thermo camera) instead of the cameras 10 may be arranged so as to monitor average body temperature.

A fraud may be also detected from individual behavior. For example, a fraud may be detected from events such that a quiet individual becomes an active one after a certain day, a non-swarming individual becomes a swarming one, the amount of feed eaten has a drastic change. Alternatively, an occurrence of fraud may be determined under a case where, although an individual has trained to make a specific action triggered by a specific sound, a specific pattern of light and the like, the individual does not make such action after a certain day.

In addition, the exemplary embodiment 1 explains a case where a fraud (livestock replacement) is reported when property information prospected to have a moderate fluctuation under a normal case has an abnormal drastic change that cannot occur during a predetermined time span. However, the information processing apparatus 100 may report a fraud (livestock replacement) even under a case where, with respect to property information prospected to have a drastic fluctuation under a normal case, fluctuation in the property information suddenly becomes small. For example, as the case where with respect to property information prospected to have a drastic fluctuation under a normal case, fluctuation in the property information suddenly becomes small, considered is a case where a young growing livestock is replaced with an old livestock assumed to have no drastic growth. That is, the information processing apparatus 100 may report the livestock replacement when it detects discontinuity (unsuccessiveness), drastic change, abnormal change in property value during a short time span from livestock images taken regularly or periodically.

In the exemplary embodiment 1, not only reporting using the reporting part 50, but also the past image and the new image that are used for fraud detection may be output as exhibits or put in an inspectable state. Under such situation, in order to increase tamper-resistance to the stored images and property information and increase reliability as the exhibits, hash values of the stored images and property information may be determined and held in a storage area separated from the images and property information. Instead of storing images and property information in a simple storage area, they may be stored in a tamper-resistant distributed storage, such as one using a blockchain or the like.

In addition, it is also considered that the present invention is applied to not only a livestock, but also a subject having growth or a subject having time dependent or age dependent irreversible change. For example, the subject may be a plant or a cultural asset (monitored over a long time span).

In addition, a criterion for reporting may be modified such that the reporting is performed when a state having a drastic change in the property information is sustained over a predetermined time period, instead that the reporting is performed at a timing of detection of the drastic change.

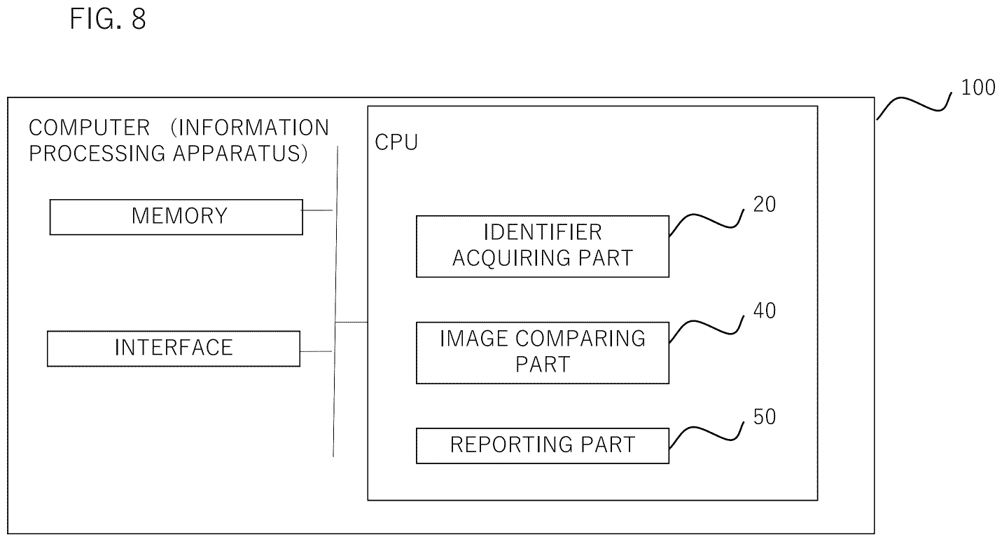

Herein, the present invention may be realized by a computer as the information processing apparatus 100. Concretely, as illustrated in FIG. 8, the computer as the information processing apparatus 100 comprises a memory (corresponding to the storage part 30), am interface (communicated with the cameras 10, CPU (Central Processing Unit), and the like. CPU reads out a program and realizes processor modules corresponding to the identifier acquiring part 20, the image comparing part 40 and the reporting part 50.

A part or entire of the exemplary embodiment may be described as the following modes, but not limited thereto.

### (Mode 1)

An information processing apparatus, comprising:
a camera that takes images of a livestock,
an identifier acquiring part that acquires an identifier of the livestock,
a storage part that stores the identifiers acquired by the identifier acquiring part and the images taken by the camera in association with one another,
an image comparing part that compares the images of the livestock identified by the same identifier, which have been taken at different time points, and
a reporting part that reports replacement of the livestock identified by the same identifier when a change in the livestock that cannot occur during a predetermined time span is detected as a result of comparison by the image comparing part.

### (Mode 2)

The information processing apparatus according to Mode 1, wherein the image comparing part acquires property information of the livestock from each of the images and performs comparison between (pieces) of the property information acquired.

### (Mode 3)

The information processing apparatus according to Mode 2, wherein the property information is body height, and the image comparing part acquires the body height of the livestock by comparing with a criterion object captured in the images.

### (Mode 4)

The information processing apparatus according to Mode 2, wherein the camera is a thermo camera, and the property information is average body temperature.

### (Mode 5)

The information processing apparatus according to Mode 2, wherein the property information is patterns on a livestock body.

### (Mode 6)

The information processing apparatus according to Mode 2, wherein
the property information is amount of feed eaten.

### (Mode 7)

The information processing apparatus according to any one of Modes 1 to 6, wherein,
when a new image is stored in the storage part, the image comparing part compares the new image with an image which has been stored at a preceding shooting.

### (Mode 8)

The information processing apparatus according to any one of Modes 1 to 7, further comprises a livestock position acquiring part that acquires a position of the livestock from the image taken by the camera, and the identifier acquiring part performs association of the images taken by the camera with the identifier based on a position of the livestock determined by the livestock position acquiring part.

### (Mode 9)

An information processing method, comprising:
an image taking step of taking images of a livestock,
an identifier acquiring step of acquiring an identifier of the livestock,
a storing step of storing the identifiers acquired and the images in association with one another in a storage part,
an image comparing step of comparing the images of the livestock identified by the same identifier, which have been taken at different time points,
a reporting step of reporting replacement of the livestock identified by the same identifier when a change in the livestock that cannot occur during a predetermined time span is detected as a result of comparison.

### (Mode 10)

An information processing program, causing a computer to execute:
an image taking process of taking images of a livestock,
an identifier acquiring process of acquiring an identifier of the livestock,
a storing process of storing the identifier acquired and the images in association with one another in a storage part, and
an image comparing process of comparing the images of the livestock identified by the same identifier, which have been taken at different time points,
a reporting process of reporting replacement of the livestock identified by the same identifier when a change in the livestock that cannot occur during a predetermined time span is detected as a result of comparison.

Herein, it is deemed that disclosure of each of the above Patent Literature is incorporated in the present application and may be used as a base or a part of the present invention as necessary. The exemplary embodiment(s) or example(s) may be modified or adjusted within the scope of the entire disclosure of the present invention, inclusive of claims, based on the basic technical concept of the invention. In addition, a variety of combinations or selections (including partial selection or non-selection) of disclosed variety elements (each element in each claim, each element in each example embodiment or each example, etc.) may be made within the entire disclosure of the present invention. That is, the present invention, of course, may cover a variety of modifications or corrections that may be made by those skilled in the art in accordance with the entire disclosure of the present invention, inclusive of claims, and the technical concept of the present invention. In particular, a numerical range described in the present application should be interpreted as specifically describing any numerical value or subrange included within said range, even if not explicitly described. Furthermore, each of the disclosure in the above cited references shall be deemed to be included in the description of the present application, if necessary, as part of the description of the present invention, in whole or in part, in combination with the description of the present application, in accordance with the concept of the present invention.

### REFERENCE SIGNS

10: camera
20: identifier acquiring part
30: storage part
40: image comparing part
50: reporting part
100: information processing apparatus
120: livestock position acquiring part
130: identifier information acquiring part
140: identifier information modifying part
150: individual property information acquiring part
160: fraud detection part

What is claimed is:

1. An information processing apparatus, comprising at least
a camera that takes images of a livestock,
a processor; and
a memory in circuit communication with the processor;
wherein the processor is configured to execute program instructions stored in the memory to implement:
acquiring an identifier of the livestock,
storing the identifier acquired by the identifier acquiring part and the images taken by the camera in association with one another,
comparing the images of the livestock identified by the same identifier, which have been taken at different time points, and
reporting replacement of the livestock identified by the same identifier when a change in the livestock that cannot occur during a predetermined time span is detected as a result of comparison by the image comparing.

2. The information processing apparatus according to claim 1, wherein
the processor acquires property information of the livestock from each of the images and performs comparison between the property information acquired.

3. The information processing apparatus according to claim 2, wherein
the property information is body height, and
the processor acquires the body height of the livestock by comparing with a criterion object captured in the images.

4. The information processing apparatus according to claim 2, wherein
the camera is a thermo camera, and
the property information is average body temperature.

5. The information processing apparatus according to claim 2, wherein
the property information is patterns on a livestock body.

6. The information processing apparatus according to claim 2, wherein the property information is amount of feed eaten.

7. The information processing apparatus according to claim 1, wherein,
when a new image is stored, the processor compares the new image with an image which has been stored at a preceding shooting.

8. The information processing apparatus according to claim 1, the processor further acquires a position of the livestock from the images taken by the camera, and
performs association of the images taken by the camera with the identifier based on a position of the livestock that has determined.

9. An information processing method
executed by an information processing apparatus comprising at least
a camera that takes images of a livestock,
a processor; and
a memory in circuit communication with the processor;
wherein the information processing method comprises:
taking images of a livestock,
acquiring an identifier of the livestock,
storing the identifiers acquired and the images in association with one another,
comparing the images of the livestock identified by the same identifier, which have been taken at different time points,
reporting replacement of the livestock identified by the same identifier when a change in the livestock that cannot occur during a predetermined period is detected as a result of comparison.

10. A non-transitory computer readable recording medium storing an information processing program, causing a computer, wherein the computer comprises at least
a camera that takes images of a livestock,
a processor; and
a memory in circuit communication with the processor,
to execute:
taking images of a livestock,
acquiring an identifier of the livestock,
storing the identifiers acquired and the images in association with one another,
comparing the images of the livestock identified by the same identifier, which have been taken at different time points, and
reporting replacement of the livestock identified by the same identifier when a change in the livestock that cannot occur during a predetermined period is detected as a result of comparison.

11. The information processing method according to claim 9, wherein the information processing method further comprises
acquiring property information of the livestock from each of the images and performing comparison between the property information acquired.

12. The information processing method according to claim 11, wherein the property information is body height, and
the information processing method further comprises acquiring the body height of the livestock by comparing with a criterion object captured in the images.

13. The information processing method according to claim 11, wherein the camera is a thermo camera, and
the property information is average body temperature.

14. The information processing method according to claim 11, wherein the property information is patterns on a livestock body.

15. The information processing method according to claim 11, wherein the property information is amount of feed eaten.

16. The information processing method according to claim 9, wherein, the information processing method further comprises
when a new image is stored, comparing the new image with an image which has been stored at a preceding shooting.

17. The information processing method according to claim 9, the information processing method further comprises acquiring a position of the livestock from the images taken by the camera, and
performing association of the images taken by the camera with the identifier based on a position of the livestock that has determined.

18. The medium according to claim 10, wherein the program further causes the computer to execute
acquiring property information of the livestock from each of the images and performing comparison between the property information acquired.

19. The medium according to claim 18, wherein
the property information is body height, and
the program further causes the computer to execute acquiring the body height of the livestock by comparing with a criterion object captured in the images.

20. The medium according to claim 18, wherein
the camera is a thermo camera, and
the property information is average body temperature.
